(19) United States
(12) Patent Application Publication
(10) Pub. No.: US 2007/0111165 A1
(43) Pub. Date: May 17, 2007

(54) Polymer Core Prosthetic Dental Device with an Esthetic Surface

(76) Inventors: Michael Wallick, Warsaw, IN (US); Kai Zhang, Warsaw, IN (US); Jeffrey A. Bassett, Vista, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/622,171

(22) Filed: Jan. 11, 2007

Related U.S. Application Data
(63) Continuation-in-part of application No. 11/420,024, filed on May 24, 2006.
(60) Provisional application No. 60/684,743, filed on May 26, 2005.

(51) Int. Cl. A61C 13/08; A61C 8/00

(52) U.S. Cl. 433/212.1; 433/173

(57) ABSTRACT

A prosthetic dental device has an inner portion formed of an inner material and an outer portion formed of an outer material that covers at least a part of the inner portion. The inner material is substantially different from the color of natural teeth while the outer material is substantially the same color as natural teeth. Both the inner material and the outer material comprise a polymer.

### CROSS REFERENCE TO RELATED APPLICATION

This application is a continuation-in-part of pending U.S. patent application Ser. No. 11/420,024, filed May 24, 2006, which claims the benefit of U.S. Provisional Patent Application No. 60/684,743, filed May 26, 2005, both of which are fully incorporated herein for all purposes.

### BACKGROUND

1. Field of the Invention.

The present invention relates to prosthetic dental devices and, more particularly, to methods and materials used to construct prosthetic dental devices.

2. Description of the Related Art.

Often, it is desirable to replace lost, missing, injured or diseased teeth using prosthetic dental devices. Prosthetic dental devices include, for example, implants which are inserted into the mandible or maxilla of a patient. Other dental devices temporarily cover the implant until a sufficient amount of bone osseointegrates with the implant to support and anchor the implant during mastication. Such devices used during this “healing process” include provisional gingival cuffs, healing screws, healing collars and healing caps. Other structures include abutments which are attached to the implant to serve as a mount for a prosthetic tooth, and may be permanent or provisional.

Some of these dental devices may be visible, or have portions that may be visible, when viewing a dental patient's face. For instance, an abutment which supports a prosthesis can have a visible area near the gums that is not covered by the prosthesis. When these visible areas are made of metals or plastics that do not have the color of natural teeth, the dental devices provide a non-esthetically pleasing appearance on a person's face. To attempt to address this shortcoming in appearance, there are dental devices that have the color of natural teeth. These devices, however, tend to lack adequate strength which may result in relatively frequent replacement or repair.

### BRIEF DESCRIPTION OF THE DRAWINGS

FIG. 1 is an exploded, cross-sectional view of a prosthetic dental device in accordance with one embodiment with features of the present invention;

FIG. 2 is a perspective view of an abutment of the device of FIG. 1;

FIG. 3 is a cross-sectional view of the abutment taken along line III-III on FIG. 2;

FIG. 4 is an exploded, cross-sectional view of another embodiment of a prosthetic dental device with features in accordance with the present invention;

FIG. 5 is a cross-sectional view of an alternative abutment in accordance with features of the present invention;

FIG. 6 is an exploded, fragmentary, perspective view of yet another embodiment of a prosthetic dental device in accordance with features of the present invention;

FIG. 7 is a cross-sectional view of an alternative provisional device in accordance with features of the present invention;

FIG. 8 is a flow chart of a general exemplary process for manufacturing a dental prosthetic device with features of the present invention; and

FIG. 9 is a flow chart of further steps for the process of FIG. 7.

### DETAILED DESCRIPTION OF THE PREFERRED EMBODIMENTS

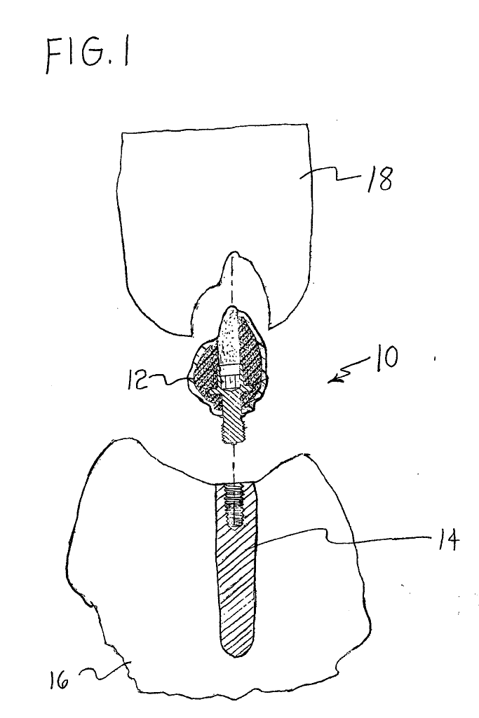

Referring to FIG. 1, a prosthetic dental device 10 is illustrated and is used for restoring an edentulous area in a dental patient's mouth. The prosthetic dental device 10 has an abutment 12 threadedly mounted on an implant 14 on a person's jaw 16 during dental surgical procedures. The jaw 16 may be the mandible or the maxilla. The abutment 12 supports a tooth-shaped prosthesis 18 that may or may not cover the entire abutment 12. A prosthesis or prosthetic tooth typically includes an inner cavity designed to accept an abutment and an outer portion that replicates the appearance and hardness of a natural tooth. The prosthetic tooth may be cemented, screwed, or otherwise fastened to the abutment.

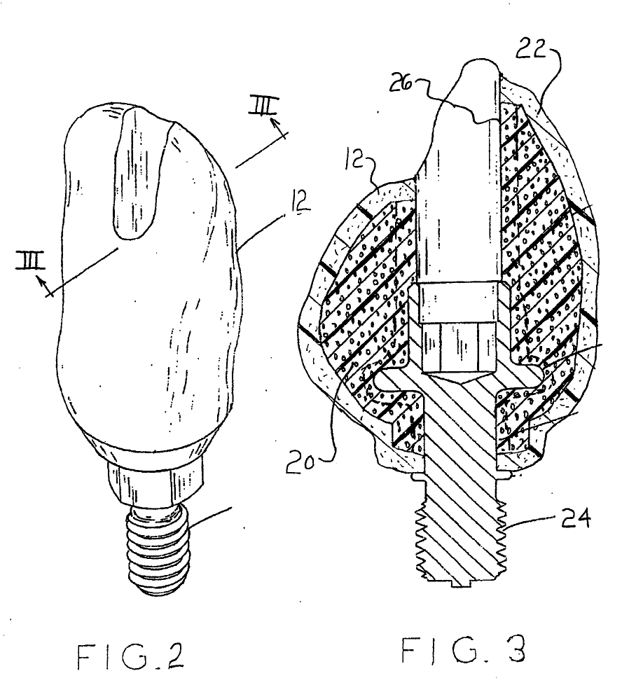

Referring to FIGS. 2-3, the abutment 12 has a core or an inner portion 20 and an esthetic outer layer or portion 22 that may be integrally formed with a metal retaining screw 24 for attachment to the implant 14. The abutment 12 has a bore 26 to provide access to the head of the screw 24 and may be plugged with cement or other material once mounted on the implant 14. The inner portion 20 is not particularly limited to any color since it is covered, as explained below, by the esthetic outer portion 22. Thus, the inner portion 20 may have a high strength polymer with a dark color or other esthetically displeasing color that is substantially different than the color of natural teeth and different than the color of the outer portion 22.

The outer portion 22 is made of an outer material with an esthetically pleasing color that is substantially the same color as natural teeth. In this example, the illustrated outer portion 22 covers substantially the entire inner portion 20. This may be provided when the prosthesis 18 is translucent and a dark colored inner portion 20 may show through the prosthesis. Of course, the outer portion 22 may also be provided covering substantially the entire inner portion 20 when it is more cost effective to do so during molding processes.

In order to provide an appropriate natural-tooth color for the outer portion 22, the outer portion is made of a polymer with a colorant. Thus, to form a strong and stable bond at the interface of the inner portion 20 and the outer portion 22, it is also desirable to form the inner portion 20 with a polymer. Optionally, the inner portion 20 and/or the outer portion 22 may be made of a composite material including a polymer mixed with a reinforcing component such as particulates, fibers, and/or porous foams described below.

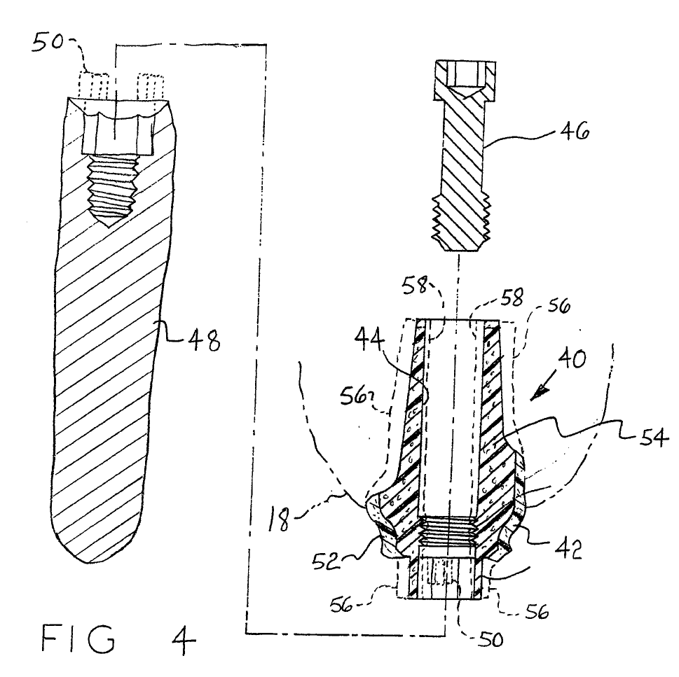

Referring to FIG. 4, by another approach, a prosthetic dental device 40 has an abutment 42 with a through-bore 44 for receiving a separate retaining screw 46 which attaches the abutment 42 to an implant 48. The implant 48 and the abutment 42 may have an anti-rotational and tactile connection structure, such as a hex connection and/or splines 50 (shown in dashed lines).

The abutment 42 has an outer portion 52 that covers at least parts of an inner portion 54 that are most likely to be left uncovered by the prosthesis 18 (shown in phantom line) such as by the gum line. Thus, when the prosthesis configuration is known, the outer portion 52 may be shaped to cover substantially only those parts of the inner portion 54 that will be left uncovered by the prosthesis. Alternatively, the outer portion 52 may have extensions 56 (as shown in dashed line), to cover more of the inner portion 52 including parts of the inner portion 52 covered by the prosthesis 18. The outer portion 54 also may have a cylindrical inner portion 58 to optionally cover the surface forming the through-bore 44.

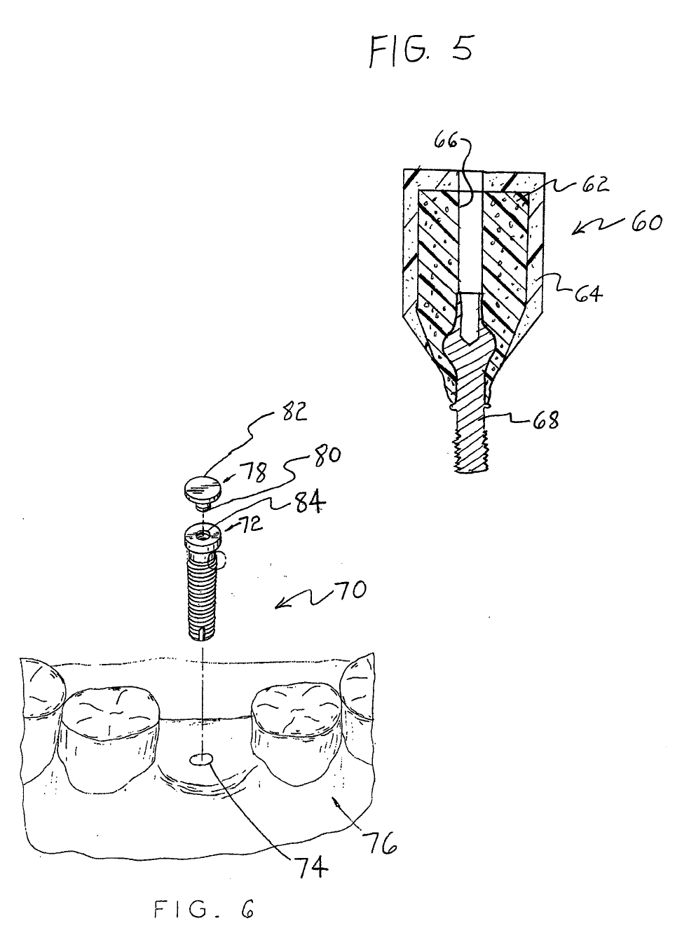

Referring to FIG. 5, a substantially cylindrical abutment 60 is illustrated and has a polymer-containing inner portion 62 of a dark, non-tooth color (such as black) covered by a polymer-containing, outer esthetic portion 64 that is substantially the same color as natural teeth (such as a white, ivory, or white-yellow shade, to name some possible examples). The abutment 60 has a bore 66 to provide access to an integrally formed retaining screw 68. The bore 66 is not coated with the material of the outer portion 64 in this example. The cylindrical abutment 60 of FIG. 5 was used for producing nine test examples, and the specific composition of the inner and outer materials for each of the nine produced examples are described in detail below.

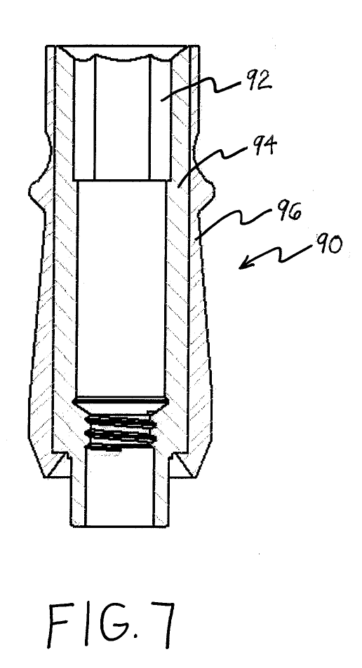

It will be appreciated that in addition to, or instead of, an abutment, the structure with an outer esthetic, polymer portion covering an inner polymer portion, may be provided on other pieces of a prosthetic dental device, including the prosthesis, the implant, and/or the retaining screw. Referring to FIG. 6, in another example, a prosthetic dental device 70 has a healing screw 78 with the described inner and outer portions. The prosthetic dental device 70 includes a threaded dental implant 72 that engages a hole 74 in a mandible 76 or maxilla, which is created during a surgical procedure or following tooth extraction. The healing screw 78 includes a threaded shaft 80 extending from a head 82. The threaded shaft 80 engages a threaded aperture 84 of the implant 72. The healing screw 78 prevents debris from entering, and gingival tissue from growing into, the aperture 84 while the mandible 76 heals during the osseointegration of the implant 72 with the mandible 76. In this case, at least the top of the head 82 of the healing screw 78 may have a polymer-based esthetic outer portion over a polymer-based inner portion.

Other dental devices also may have the described inner and outer portions such as a gingival cuff which is meant to be placed near the gum line. Provisional devices used during osseointegration between the implant and the jaw bone or while a restoration, such as a coping or crown, is being fabricated, also may have the described structure. This may include a temporary healing cap or collar placed over an abutment integrally formed with an implant. In some embodiments, a provisional device, such as a fixture mount 90 as shown in FIG. 7, may be used to place the implant into the surgical site. For example, a screw shaped implant connected to the fixture mount 90 could be threaded into the site by applying a driving tool to a polygonal recess 92 on the fixture mount. This fixture mount 90 would be pre-assembled to the dental implant by the manufacturer. An inner polymer portion 94 of the fixture mount 90 would have adequate material strength to withstand loads associated with driving the thread. An outer portion 96 would provide a tooth colored covering so that the fixture mount 90 can remain in place during healing and provide an esthetic temporary restoration.

In any of the embodiments illustrated as described herein, both the inner portion and the outer portion are made of a polymer material. The polymer material can be a thermoplastic polymer including, without limitation, a poly(aryl ketone), including aromatic polyether ketones, such as polyether ether ketone (PEEK), polymethylmethacrylate (PMMA), polyaryl ether ketone (PAEK), polyether ketone (PEK), polyether ketone ether ketone ketone (PEKEKK), polyether ketone ketone (PEKK), and/or polyetherimide (PEI), polysulfone (PSu), and polyphenylsulfone (PPSu), or a combination of thermoplastic polymers. One suitable polymer is ULTEM® polyetherimide available from General Electric Plastics, Inc. headquartered in Pittsfield, Mass. Another suitable polymer is Radele® polyphenylsulfone available from Solvay Advanced Polymers, LLC, headquartered in Alpharetta, Ga. Other sufficient PEEK polymers include PEEK GATONE™ (provided by Gharda, Inc., Mumbai, India), PEEK 450 (provided by Victrex, Inc., Lancashire, United Kingdom), and PEEK-CLASSIX® (provided by Invibio, Inc., Lancashire, United Kingdom). An acceptable PEKK polymer includes PEKK A1050 (provided by Polymics, Inc., State College, Pa.).

By one approach, and as used for the nine produced examples, at least one of the inner portion and the outer portion are formed of PEEK or PEKK. Alternatively, both the inner portion and the outer portion may be formed of the same polymer or one portion may be formed of PEEK while the other portion is formed of PEKK.

In order to strengthen the inner and/or outer portions, the inner and /or outer material may be a composite material that includes a reinforcing component. The reinforcing component can be particles, fibers, and/or porous foams, including, without limitation, carbon, alumina, zirconia, yttria-stabilized zirconia, magnesium-stabilized zirconia, E-glass, S-glass, calcium phosphates, alumina, titanium dioxide, and/or calcium phosphates, such as hydroxyapatite or a biphasic calcium phosphate comprised of hydroxyapatite and tricalcium phosphate which also improve osseointegration of the dental device with surrounding bone. The fibers also may be other metal or alloy-based materials such as titanium, Ti₆Al₄V, Ta, stainless steel, and/or 316L stainless steel, or may even be made of the polymers themselves, such as PEEK, PEKK, or other aramid fibers such as Kevlar® (provided by E.I.duPont de Nemours and Co., Wilmington, Del.). A polymer reinforcing component may be placed in the same polymer material forming the bulk or matrix of the inner or outer portions.

The proportion of reinforcing component, such as ceramic particles or fibers, in the inner or outer composite material is equal to or less than approximately 70% by weight of the total inner or outer composite material, preferably between approximately 20 to 60% and, most preferably, between approximately 30 to 50%. In one case, the fibers are provided at about 30%, and in another case, the fibers are provided at about 35%. The proportion may be equal to or less than approximately 99% when, for example, the reinforcing component is relatively heavy, metal-based fibers or foam, such as a Ta foam.

The reinforcing component, also referred to as a filler material, can include, without limitation, spherical shapes, elongate fibers, or other shapes. In one example, the reinforcing component includes nanoparticles with a size range from about 1 nm to about 100 nm, and/or microparticles with a size range from about 100 nm to about 100 μm. These fibers may have a length-to-diameter ratio in a range of about 1 to 1000. In some cases, this ratio may be as low as about 10, 20, or 25 and as high as about 100, 150 or 1000. The length of the fibers can vary to as short as about 1 mm and as long as about 50 mm. In a number of the nine produced examples described below, fibers were about 1-2 mm long and had length-to-diameter ratios of about 8-16. Other examples provide more desirable length-to-diameter ratios of about 250 to 860, where the lengths of the fibers are 5-6 mm.

The fibers may have a varying diameter in order to increase resistance to wear, and may include various types of fibers and particles including nanoparticles that fuse to fibers to increase the fracture toughness of the composite material or to control the color of the composite material. These alternative features are explained in detail in the parent U.S. patent application.

As mentioned above, the outer material is substantially the same color as natural teeth. The raw polymer materials PEEK-CLASSIX® and ULTEM® are obtained with the colorant already mixed with the polymer. For other raw polymer materials, the colorant must be added to the polymer to obtain the desired natural-tooth color. In one example, the colorant mixed with the polymer is an inorganic material, such as rutile and/or titanium dioxide (TiO₂). In this case, the colorant is provided, by total weight of the inner or outer composite material, at about approximately less than 20%, but preferably approximately between 5 to 15% and, more preferably, between 7 to 12%. For some of the nine produced examples, the colorant is provided at approximately 10% of the composite material weight. The colorant also is provided with a particle size of about 0.1 to 100 μm and, more preferably, from about 0.1 to 10 μm and, most preferably, from about 0.5 to 5 μm.

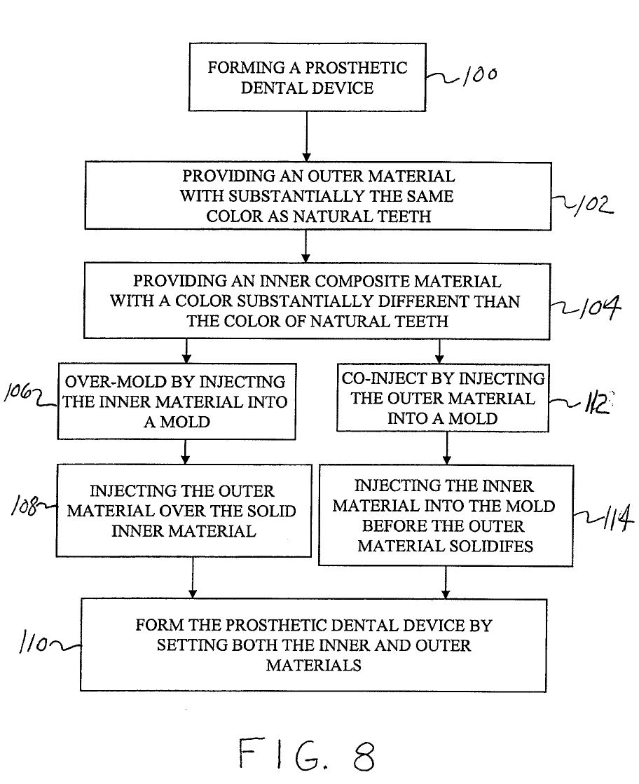

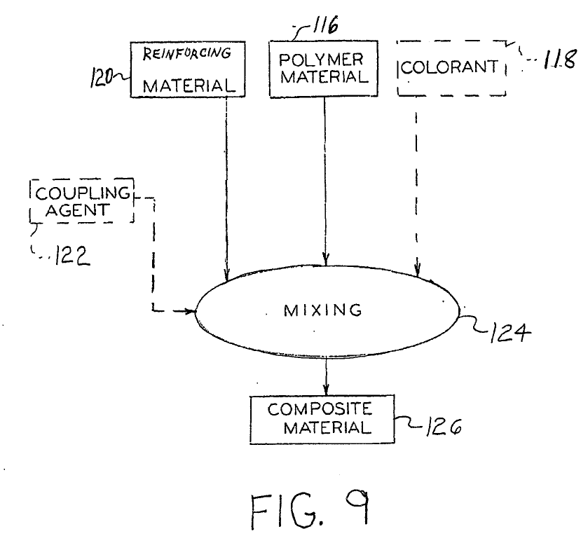

Referring to FIGS. 8-9 , a method for forming 100 a prosthetic dental device includes providing 102 an outer material. As mentioned above, a raw polymer material that already has a desired esthetic color and/or is pre-mixed with a reinforcing component may be obtained. In this case, the raw material is provided in pellets that may only need milling to a desired size before the pellets are ready to be heated for injection into a mold.

In the alternative, a compounding process may be used to heat a polymer material 116, a separately provided colorant 118 (if present), and/or a separately provided reinforcing component 120 (if present) into a viscous state and mechanically mix 124 the heated substances into a composite material 126. Before compounding, dry pre-blending may be performed to better achieve good dispersion using a suitable mixer, such as a Sigma-type mixer, if necessary. In one embodiment, the polymer material may possess a desired viscous state at substantially room temperature and may not need to be heated. It is desirable to mix the composite material 126 until the colorant 118 and the reinforcing component 120 is substantially evenly distributed throughout the polymer material. Subsequently, the composite material 126 is extruded or pressed through an orifice of a die. As the composite material exits the orifice, it is cut into small, semi-cylindrical pieces, or pellets. This compounding process may be performed using a ZSK-25 twin screw extruder. Alternatively, the composite material may be directly inserted into a mold. It will also be understood that the composite material could be formed into at least one block that is subsequently altered into a desired shape.

Prior to, or contemporaneous with, the compounding process described above, the reinforcing component 120, or the composite material 126, may optionally be treated with a coupling agent 122 in order to increase molecular bonding in the material and between the inner and outer portions. The coupling agents, such as silane and others, and their use are described in detail in the parent U.S. patent application.

Pellets ready for injection molding are then transferred into an injection molding machine, in which the outer material, for example, and particularly the polymer material component, is heated to obtain a desired viscosity unless the outer material possesses a desired viscous state at substantially room temperature. Once the material is in a desired viscous state, it is injected as described below. During this process, the reinforcing component and colorant, if present, remains substantially suspended within the polymer material. The same process for providing the outer material may be used to provide the inner material 104 as well.

For the nine produced examples described below, an over-molding or two-stage molding injection process (also called multi-component, transfer or insert molding) was used to form the prosthetic devices with an Engel 100 TL injection molding machine. In order to mold the inner and outer portions, the material for the inner portion was injected 106 into a first mold for forming the inner portion or core of an abutment and over a retainer screw. Once the core was sufficiently cooled and solidified, it was inserted into a second mold. The material for the esthetic outer portion was then injected 108 into the second mold and over the solidified inner portion. Although the two materials are injected separately, a chemical bond or a mechanically interlocking structure may be formed between the two portions. The materials are then permitted to cool to form 110 of the dental device.

Alternatively, the examples may be formed by co-injection molding. In this process, a single mold is used and the outer material is injected 112 into the mold first to form the esthetic outer portion. When the outer material is injected, it forms a fountain flow and begins to fill and coat the outer surfaces of the mold cavity. The inner material is then injected 114 immediately following the outer material before can cool and solidify. This results in improved bonding and interlocking properties at the interface between the inner and outer portions. The materials then set in the mold to form 110 the prosthetic dental device.

After sufficient time has elapsed, the prosthetic dental device is in a substantially solid form and can be removed from the mold. Subsequent to either injection molding process 106 or 112, the prosthetic dental device can be machined and polished to reduce undesired deformities and surface roughness. Additionally, the outer surface of the dental device may be treated by a gas plasma cleaning process to enhance bonding between the prosthetic dental device and an adhesive that may be used to attach to a prosthesis, for example, if desired.

With this method, any number of different composite and non-composite materials may be injected sequentially to form an integrated dental device. Thus, the prosthetic dental device may have other layers in addition to the inner and outer portions described above. The color of each layer may be selected to provide a range or gradient of colors in the same device. Further, the materials for each layer may be selected to provide different structural or chemical properties in different regions of the prosthetic dental device. Such extra layer or layers may be formed under the inner portion, between the inner and outer portions, or over the outer portion. It will be appreciated that the surface finish and other optical properties, including, without limitation, reflectance, opacity and specularity also can be adjusted by the selection of the polymer material, the reinforcing component, and/or additives as mentioned herein.

### EXAMPLES

Below are descriptions of nine produced examples of prosthetic dental device structures with inner and outer portions as described above. The compositions of the materials for each produced example are listed in Table I as well as described below. While these examples were provided for a cylindrical abutment such as that depicted in FIG. 5, the composition for the inner and outer portions for each example could be used on any of the other dental devices described herein and any other dental device that requires both strength for mastication and a natural-tooth color. All percentages below are weight percentages unless indicated otherwise.

For Examples 1-6, the outer esthetic material is made from a raw polymer or composite material that is already premixed with a colorant to provide a natural tooth color. For Examples 7-9, a separate colorant is mixed with the raw polymer or composite material to establish the natural-tooth color.

TABLE I

| | ABUTMENT INNER PORTION | | ABUTMENT OUTER PORTION | | |
|---|---|---|---|---|---|
| | | Reinforcing | | Reinforcing | |
| EX. | Polymer | Component | Polymer | Component | Colorant |
| 1 | PEEK GATONE ™ | 30% wt. carbon fiber | ULTEM ® | none | (not available) |
| | 5330 CF | | 1010 | | |
| 2 | PEEK GATONE ™ 5330 | 30% wt. carbon fiber | PEEK- | none | N/A |
| | CF | | CLASSIX ® | | |
| 3 | PEEK 450 | 30% wt. alumina fibers. | PEEK- | none | N/A |
| | | | CLASSIX ® | | |
| 4 | PEKK A1050 | 30% wt. alumina fibers. | PEEK- | none | N/A |
| | | | CLASSIX ® | | |
| 5 | PEKK A1050 | 30 wt. % zirconia fibers | ULTEM ® | none | N/A |
| | | | 1010 | | |
| 6 | PEKK A1050 | 30 wt. % zirconia fibers | PEEK- | none | N/A |
| | | | CLASSIX ® | | |
| 7 | PEKK A1050 | None | PEKK A1050 | 35 wt. % E-glass | 10 wt. % |
| | | | | fibers | TiO₂ |
| 8 | PEEK GATONE ™ 5330 | 30% wt. carbon fiber | PEKK A1050 | 35 wt. % E-glass | 10 wt. % |
| | CF | | | fibers | TiO₂ |
| 9 | PEEK 450 | None | PEKK A1050 | 35 wt. % E-glass | 10 wt. % |
| | | | | fibers | TiO₂ |

### Example 1

In this example, the inner material is a composite with polyether ether ketone and specifically PEEK GATONE™ 5330 CF (provided by Gharda, Inc.). The PEEK is provided in pellets premixed with about 30 wt. % carbon fibers. More specifically, the carbon fibers comprise about 30% of the combined weight of the carbon fibers and PEEK mixed together. The inner composite material has a dark black color.

For the outer material, ULTEM® 1010 polyetherimide (by GE Plastics, Inc.) is provided as pellets pre-mixed with colorant in its raw form. This outer material is substantially the same color as natural teeth and has low translucency so that the black inner material is substantially undetectable through the outer material.

As explained above for the process illustrated in FIGS. 8-9, the inner composite material was heated and injected into a first mold for forming the core of the abutment. It was then permitted to cool before placing the solidified core in a second mold. The outer material was then heated and injected into the second mold and over the inner material where it was permitted to cool to complete the dental abutment. Once cooled, the abutment was removed from the mold and machined and/or cleaned as required.

### Example 2

In this example, the method of producing an abutment was the same method as described in Example 1, except the ULTEM® 1010 polyetherimide for the outer material was replaced with the PEEK-CLASSIX® polymer which is also substantially the same color as natural teeth and has low translucency. The carbon fibers in the inner composite material have a length of about 5-6 mm and a diameter of about 7 μm for a length-to-diameter ratio in a range of about 715 to 860.

### Example 3

In this example, the inner composite material includes the polymer PEEK 450 (by Victrex Inc.) provided as pellets. The PEEK was milled into a powder and sieved with a 200 mesh sieve. About 30 wt. % alumina fibers (AlO₂) were then mixed with the PEEK in a Sigma-type mixer to provide the reinforcing component. The alumina fibers have a diameter of about 120 μm and a length of about 1-2 mm for a length-to-diameter ratio of about 8 to 16. The inner composite material in powder form was then compounded with a ZSK-25 twin-screw extruder into composite pellets. This forms an inner material that is dominantly grey with the fibers visible as light colored specks. The outer material included PEEK-CLASSIX® polymer prepared as explained above for the outer material of Example 2. Thereafter, the inner and outer mixtures were heated and separately injected into a mold cavity to form a dental abutment as also explained above in Example 1.

### Example 4

In this example, the esthetic outer material is the same as Example 3 and is prepared in the same manner. For the inner composite material, the PEKK A1050 polymer (by Polymics, Inc.) is mixed and compounded with about 30 wt. % alumina fibers (AlO₂) of about the same size as the fibers of Example 3. The inner composite material is black with fibers showing as light colored specks. Both the inner and outer materials were injected as explained above for Example 1.

### Example 5

In this example, the inner composite material includes PEKK A1050 with about 30 wt. % zirconia fibers (ZrO₂) present as a reinforcing component. The zirconia fibers also have a diameter of about 120 μm and a length of about 1-2 mm. The PEKK and zirconia fibers were mixed and compounded as described above for the inner material of Example 3 and formed a black substance with the zirconia fibers showing as light colored specks. Here, the substantially tooth-colored ULTEM® 1010 was used as the esthetic outer material. Both the inner and outer materials were injected as explained above for Example 1.

### Example 6

In this example, the method of producing an abutment was the same as the method described in Example 5, except the esthetic outer material was PEEK-CLASSIX® instead of the ULTEM® 1010.

Example 7

In this example, the inner material is the black PEKK A1050 polymer without a further reinforcing component, and the outer composite material is the PEKK A1050 polymer mixed and compounded with 35 wt. % of E-glass fibers as the primary reinforcing component and 10 wt. % of titanium dioxide (TiO₂) as a colorant to provide the outer composite material with a color substantially the same as natural teeth. The E-glass fibers have a length of about 5-6 mm and a diameter of about 10-20 μm for length-to-diameter ratios of about 250 to 600. Both the inner and outer materials were injected as explained above for Example 1.

### Example 8

In this example, a mechanically strong carbon reinforced material is used to form the inner portion of a prosthetic component while a TiO₂ filled material is used to form the outer portion. The carbon reinforced inner portion, composite material is a dark color, which is unattractive for a dental application, but is covered with a white, esthetically pleasing TiO₂ filled outer, composite material. More specifically, the outer composite material is the same as that for Example 7, while the inner composite material is the PEEK GATONE™ 5330 CF with pre-mixed carbon fibers instead of the PEKK A1050. Thus, the method for mixing and compounding the outer composite material is as explained for Example 7 and the method of injecting both the inner and outer materials is as explained for Example 1. The carbon fibers of the inner material provided a length-to-diameter ratio of 715 to 860, while the length-to-diameter ratio of the outer material is about 250 to 600.

### Example 9

In this example, the outer composite material was the same as that for Example 7 including the TiO₂ colorant, while the inner material is the black PEEK 450 without a further reinforcing component. Thus, the method for mixing and compounding the outer material is as explained for Example 7, while the method of injecting both the inner and outer materials is as explained for Example 1.

TABLE II
INNER PORTION MECHANICAL PROPERTIES

| | | | Average | | Average | | | | | |
|---|---|---|---|---|---|---|---|---|---|---|
| | | | Modulus | | Tensile | | Avg. | | | Izod |
| | | | of | | Yield | Yield | Tensile | Max | | Impact |
| | | | Elasticity | Modulus | Strength | Strength | Max Strain | Strain | Shore D | Energy |
| EX | Polymer | Ceramic | (ksi) | Std. Dev. | (ksi) | Std. Dev. | (%) | Std. Dev. | Hardness | (J/m) |
| 1 | PEEK | 30 wt. % | 3146 | * | 31.5 | * | 2.5 | * | * | 80 |
| | GATONE ™ | Carbon | | | | | | | | |
| | 5330CF | fibers | | | | | | | | |
| 2 | PEEK | 30 wt. % | 3146 | * | 31.5 | * | 2.5 | * | * | 80 |
| | GATONE ™ | Carbon | | | | | | | | |
| | 5330CF | fibers | | | | | | | | |
| 3 | PEEK 450 | 30 wt. % | 746 | 58 | 12.5 | 0.1 | 8.3 | 1.6 | * | * |
| | | Al₂O₃ | | | | | | | | |
| | | fibers | | | | | | | | |
| 4 | PEKK | 30 wt. % | 791 | 100 | 11.2 | 0.1 | 6.8 | 1.2 | * | * |
| | A1050 | Al₂O₃ | | | | | | | | |
| | | fibers | | | | | | | | |
| 5 | PEKK | 30 wt. % | 712 | 82 | 11.8 | 0.1 | * | * | * | * |
| | A1050 | ZrO₂ fibers | | | | | | | | |
| 6 | PEKK | 30 wt. % | 712 | 82 | 11.8 | 0.1 | * | * | * | * |
| | A1050 | ZrO₂ fibers | | | | | | | | |
| 7 | PEKK | NONE | 500 | * | 13 | * | 80 | * | 86 | 50 |
| | A1050 | | | | | | | | | |
| 8 | PEEK | 30 wt. % | 3146 | * | 31.5 | * | 2.5 | * | * | 80 |
| | GATONE ™ | Carbon | | | | | | | | |
| | 5330CF | fibers | | | | | | | | |
| 9 | PEEK 450 | NONE | 522 | * | 13.3 | * | 50 | * | * | * |

TABLE III
OUTER PORTION MECHANICAL PROPERTIES

| | | | Average | | Average | | | | | |
|---|---|---|---|---|---|---|---|---|---|---|
| | | | Modulus | | Tensile | | Avg. | | | |
| | | | of | | Yield | Yield | Tensile | Max | | Izod Impact |
| | | | Elasticity | Modulus | Strength | Strength | Max Strain | Strain Std. | Shore D | Energy |
| EX | Polymer | Ceramic | (ksi) | Std. Dev. | (ksi) | Std. Dev. | (%) | Dev. | Hardness | (J/m) |
| 1 | ULTEM ® | NONE | 475 | * | 16.5 | * | 80 | * | * | 27 |
| | 1010 | | | | | | | | | |
| 2 | PEEK- | NONE | 391 | 28 | 14.2 | 0.1 | 76.5 | 3.9 | * | 36 |
| | CLASSIX ® | | | | | | | | | |
| 3 | PEEK- | NONE | 391 | 28 | 14.2 | 0.1 | 76.5 | 3.9 | * | 36 |
| | CLASSIX ® | | | | | | | | | |
| 4 | PEEK- | NONE | 391 | 28 | 14.2 | 0.1 | 76.5 | 3.9 | * | 36 |
| | CLASSIX ® | | | | | | | | | |
| 5 | ULTEM ® | NONE | 475 | * | 16.5 | * | 80 | * | * | 27 |
| | 1010 | | | | | | | | | |
| 6 | PEEK- | NONE | 391 | 28 | 14.2 | 0.1 | 76.5 | 3.9 | * | 36 |
| | CLASSIX ® | | | | | | | | | |
| 7 | PEKK A1050 | 35 wt % | 957 | 82 | 16.4 | 0.1 | 2.3 | 0.1 | * | 52 |
| | | E-glass | | | | | | | | |
| | | fibers, | | | | | | | | |
| | | 10 wt % | | | | | | | | |
| | | TiO₂ | | | | | | | | |
| 8 | PEKK | 35 wt % | 957 | 82 | 16.4 | 0.1 | 2.3 | 0.1 | * | 52 |
| | A1050 | E-glass | | | | | | | | |
| | | fibers, | | | | | | | | |
| | | 10 wt % | | | | | | | | |
| | | TiO₂ | | | | | | | | |
| 9 | PEEK | 35 wt % | 957 | 82 | 16.4 | 0.1 | 2.3 | 0.1 | * | 52 |
| | A1050 | E-glass | | | | | | | | |
| | | fibers, | | | | | | | | |
| | | 10 wt % | | | | | | | | |
| | | TiO₂ | | | | | | | | |

Referring to Table II, the inner composite material produced by the method disclosed in Examples 1, 2 and 8 has a modulus of elasticity, or tensile modulus, of about 3146 ksi. To determine the modulus of elasticity, or tensile modulus, a specimen of the inner and outer material was placed in tension using ASTM D-6389 Standards and the resulting deflection was recorded. The modulus of elasticity also can be determined by placing a specimen of the composite material in compression and similarly recording the deflection. One way the modulus of elasticity for the inner material can be increased above 3146 ksi, if desired, is by increasing the amount of fiber present. Alternatively, the modulus of elasticity may be increased by (1) increasing the fiber aspect ratio (length-to-diameter ratio), where applicable, (2) further improving the interface or bonding between the reinforcing component and polymer materials via coupling agents, and (3) improving the compounding and molding processes to better mix the reinforcing component within the plastic material to achieve a more even distribution and to decrease the inclusion of impurities and porosities in the composite material. Thus, one examplary desired range for the plastic modulus of the inner material is 3146 ksi or greater. The ways to increase the modulus of elasticity are not limited to the inner material and apply equally to the outer material.

Referring to Table III, the outer composite material produced by the method disclosed in Example 2 had an average modulus of elasticity, of about 391 ksi. This includes values within ±28 standard deviation from the average value. Thus, in this example, the range of an average modulus of elasticity of about 391 ksi would include values as low as about 363 ksi and as high as about 419 ksi. For the outer composite material of Example 8, the average modulus of elasticity is about 957 ksi including a modulus as low as about 875 ksi and as high as 1039 ksi due to a ±82 standard deviation. Thus, the desired elastic modulus is equal to or greater than about 363 ksi (Example 2) or equal to or greater than 875 ksi (Example 8).

With either Example 2 or Example 8, it is shown that an abutment can be formed with a modulus of elasticity of the inner portion greater than the modulus of elasticity of the outer portion. This permits the use of esthetically pleasing but relatively weaker materials to form the outer portion. In Example 2, the elastic modulus of the inner portion is at least about eight times greater than that of the outer portion, while for Example 8 the elastic modulus of the inner portion is at least about three times greater than that of the outer portion.

As seen in Tables II and III, the modulus of elasticity of the composite material generally depends on at least the polymer material, and the type and quantity of reinforcing components mixed within the polymer material. The modulus of elasticity also depends on whether the reinforcing component includes continuous or non-continuous fibers, and whether the fibers are oriented with the load directions. For a continuous fiber-reinforced composite, i.e., composites where the fiber length is much larger than the critical fiber length, in which the fiber is aligned in the same direction of the load, the modulus of elasticity of the composite, Ec, is determined by Equation (1) below:
E_{c}=VₘEₘ+V_{f}E_{f} Equation (1)
wherein Eₘ and E_{f} are the moduli of the polymer matrix and the ceramic fibers, respectively, and Vₘ and V_{f} are the volumes of polymer matrix and ceramic fibers, respectively, such that Vₘ+V_{f}=1. The critical length of the fiber is dependent on the fiber diameter, the fiber's ultimate strength, and the bond strength between the fiber and the plastic matrix. For a number of combinations, this critical length is on the order of about 1 mm. For a continuous fiber-reinforced composite in which the fiber is aligned in the transverse direction to the load, the composite modulus of elasticity is determined by Equation (2) below:
1/E_{c}=Vₘ/Eₘ+V_{f}/E_{f}. Equation (2)
For discontinuous and randomly oriented fibers, the composite modulus of elasticity is determined by Equation (3) below:
E_{c}=VₘEₘ+KV_{f}E_{f} Equation (3)
in which K is a fiber efficiency parameter which depends upon the ratio of V_{f} and E_{f}/Eₘ. K is usually in the range of 0.1-0.6. In any event, the upper and lower bounds of the modulus of elasticity for the composites composed of particulate fillers are determined by Equations (4) and (5) below:
E_{c} (upper)=VₘEₘ+VₚEₚ Equation (4)
E_{c} (lower)=EₘEₚ/(VₘEₚ+VₚEₘ) Equation (5)

For an alternative prosthetic dental device, a composite material for the inner or outer portions may include a ceramic matrix with pores, and an organic material, such as a thermoset plastic, contained in the pores. This alternative composite material also is fully described in detail in the parent application.

It will be understood that various changes in the details, materials, and arrangements of parts and components, which have been herein described and illustrated in order to explain the nature of the invention, may be made by those skilled in the art within the principle and scope of the invention as expressed in the appended claims.

What is claimed is:

1. A prosthetic dental device comprising:
an inner portion formed of an inner material;
an outer portion formed of an outer material and covering at least a part of the inner portion; and
wherein the inner material and the outer material are of different colors and the inner material is substantially different from the color of natural teeth, the outer material is substantially the same color as natural teeth, and both the inner material and the outer material comprise a polymer.

2. The prosthetic dental device of claim 1 wherein the polymer of at least one of the inner and outer materials comprises a poly (aryl ketone).

3. The prosthetic dental device of claim 1 wherein the polymer of at least one of the inner and outer materials comprises at least one of a polyethyl ketone ketone and a polyethyl ethyl ketone.

4. The prosthetic dental device of claim 1 wherein the polymer of one of the inner and outer materials comprises a polyethyl ethyl ketone and the polymer of the other of the inner and outer materials comprises a polyethyl ketone ketone.

5. The prosthetic dental device of claim 1 wherein at least one of the inner and outer materials comprises a composite material comprising a reinforcing component and the polymer.

6. The prosthetic dental device of claim 5 wherein the reinforcing component is in the shape of at least one of: particulate, fiber, and porous foam.

7. The prosthetic dental device of claim 5 wherein the reinforcing component comprises at least one element selected from the group consisting of: ceramic, metal, and polymer.

8. The prosthetic dental device of claim 5 wherein the reinforcing component comprises at least fibers made of at least one element selected from the group consisting of: carbon, Al₂O₃, ZrO₂, Y₂O₃-stabilized ZrO₂, MgO-stabilized ZrO₂, E-glass, S-glass, calcium phosphate, hydroxyapatite, TiO₂, Ti, Ti₆Al₄V, Ta, stainless steel, 316L stainless steel, polyethyl ethyl ketone, polyethyl ketone ketone, and an aramid.

9. The prosthetic dental device of claim 5 wherein the inner material comprises a first composite material with the reinforcing component comprising at least one element selected from the group consisting of carbon fibers, alumina fibers, and zirconia fibers, and
wherein the outer material comprises a second composite material with the reinforcing component comprising fibers of at least one of E-glass, zirconia, and alumina.

10. The prosthetic dental device of claim 5 wherein the reinforcing component comprises approximately 99% or less of the total weight of the composite material.

11. The prosthetic dental device of claim 5 wherein the reinforcing component comprises approximately 70% or less of the total weight of the composite material.

12. The prosthetic dental device of claim 5 wherein the reinforcing component comprises approximately 30% to 50% of the total weight of the composite material.

13. The prosthetic dental device of claim 5 wherein the reinforcing component comprises approximately 35% of the total weight of the composite material.

14. The prosthetic dental device of claim 5 wherein the reinforcing component comprises approximately 30% of the total weight of the composite material.

15. The prosthetic dental device of claim 1 wherein the outer material further comprises a colorant.

16. The prosthetic dental device of claim 15 wherein the colorant comprises titanium dioxide.

17. The prosthetic dental device of claim 1 wherein the outer material comprises a composite material comprising the polymer of the outer portion, a reinforcing component, and a colorant.

18. The prosthetic dental device of claim 1 wherein the outer material further comprises a colorant being less than or equal to approximately 20% of the total weight of the outer material.

19. The prosthetic dental device of claim 1 wherein the outer material further comprises a colorant being approximately 5 to 15% of the total weight of the outer material.

20. The prosthetic dental device of claim 1 wherein the outer material further comprises a colorant being approximately 7 to 12% of the total weight of the outer material.

21. The prosthetic dental device of claim 1 wherein the outer material further comprises a colorant having a particle size of approximately 0.01 μm to 100μm.

22. The prosthetic dental device of claim 1 wherein the outer material further comprises a colorant having a particle size of approximately 0.1 μm to 10 μm.

23. The prosthetic dental device of claim 1 wherein the outer material further comprises a colorant having a particle size of approximately 0.5 μm to 5 μm.

24. The prosthetic dental device of claim 1 wherein the modulus of elasticity of the inner material is greater than approximately 3146 ksi, and the modulus of elasticity of the outer material is greater than approximately 363 ksi.

25. The prosthetic dental device of claim 24 wherein the modulus of elasticity of the outer material is between approximately 363ksi to 419 ksi.

26. The prosthetic dental device of claim 1 wherein the modulus of elasticity of the outer material is greater than approximately 3146 ksi, and the modulus of elasticity of the outer material is greater than approximately 875 ksi.

27. The prosthetic dental device of claim 26 wherein the modulus of elasticity of the outer material is between approximately 875 ksi and 1039 ksi.

28. The prosthetic dental device of claim 1 wherein the outer portion is disposed substantially only on a part of the inner portion that is adapted to remain uncovered when the prosthetic dental device is positioned in a human's mouth.

29. The prosthetic dental device of claim 1 wherein the prosthetic dental device comprises an abutment.

30. The prosthetic dental device of claim 1 wherein the prosthetic dental device comprises at least one of:
a dental implant adapted to be at least partially embedded in bone;
a prosthesis adapted to be mounted on an abutment;
a healing screw;
a gingival cuff;
a fixture mount;
a healing cap; and
a healing collar.

31. A prosthetic dental device comprising:
an inner portion having a color substantially different from the color of natural teeth and an inner composite material comprising:
a polymer comprising at least one of polyethyl ethyl ketone and polyethyl ketone ketone, and
a fiber reinforcing component comprising at least one element selected from the group consisting of carbon fibers, alumina fibers, and zirconia fibers; and
an outer portion having a color different than the color of the inner portion and being substantially the same color as natural teeth, the outer portion covering at least a portion of the inner composite material and comprising an outer composite material comprising:
a polymer comprising at least one of polyethyl ethyl ketone and polyethyl ketone ketone, and
a fiber reinforcing component comprising E-glass fibers.

32. The prosthetic dental device of claim 31 wherein the outer layer further comprises a colorant.

33. The prosthetic dental device of claim 32 wherein the colorant comprises TiO₂.

34. The prosthetic dental device of claim 31 wherein the inner and outer composite materials both comprise polyethyl ethyl ketone, and wherein the inner and outer composite materials have different elastic moduli.

35. The prosthetic dental device of claim 31 wherein the inner composite material comprises polyethyl ethyl ketone and the outer composite material comprises polyethyl ketone ketone.

36. A prosthetic dental device comprising:
an implant configured for mounting at a jaw; and
an abutment mounted on the implant and comprising an inner material substantially different from the color of natural teeth and an outer material substantially the same as the color of natural teeth, wherein a color of the inner material and a color of the outer material are substantially different to each other, wherein the outer material is disposed on at least a portion of the inner material, and wherein the inner material and the outer material both comprise a polymer.

37. The prosthetic dental device of claim 36 wherein the elastic modulus of the inner material is greater than the elastic modulus of the outer material.

38. The prosthetic dental device of claim 36 wherein the elastic modulus of the inner material is at least approximately three times greater than the elastic modulus of the outer material.

39. The prosthetic dental device of claim 36 wherein the elastic modulus of the inner material is at least approximately eight times greater than the elastic modulus of the outer material.

40. The prosthetic dental device of claim 36 wherein both the inner and outer materials further comprise a reinforcing component and at least one of polyethyl ethyl ketone and polyethyl ketone ketone.

41. The prosthetic dental device of claim 36 wherein the outer material further comprises a fiber reinforcement component and a colorant.

42. A method of forming a prosthetic dental device comprising:
providing an outer material comprising at least a polymer and having a color substantially the same as the color of natural teeth;
providing an inner composite material comprising a polymer and a reinforcing component and having a color substantially different from the color of natural teeth and being different than the color of the outer material;
injecting the outer material into a mold to thereby form an outer layer of the prosthetic dental device;
injecting the inner composite material into a mold to thereby form a core of the prosthetic dental device; and
forming the prosthetic dental device.

43. The method of claim 42 wherein the inner composite material is injected and solidified before the outer material is injected over the inner composite material.

44. The method of claim 42 wherein the inner composite material is injected into the mold before the outer material has solidified in the mold.

45. The method of claim 42 wherein the polymer of both the outer and inner materials comprises at least one of: polyethyl ethyl ketone and polyethyl ketone ketone.

46. The method of claim 42 further comprising:
mixing a colorant into the outer material prior to injection into the mold.

47. The method of claim 46 wherein the colorant comprises TiO₂.
